(19) United States
(12) Patent Application Publication
(10) Pub. No.: US 2004/0253948 A1
(43) Pub. Date: Dec. 16, 2004

(54) Multiple-group coordination for a robust, low-delay, fast reconfiguring wireless system

(76) Inventor: Kenneth P. Laberteaux, Ann Arbor, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/867,133

(22) Filed: Jun. 14, 2004

Related U.S. Application Data
(60) Provisional application No. 60/478,121, filed on Jun. 12, 2003.
(60) Provisional application No. 60/515,634, filed on Oct. 30, 2003.

(51) Int. Cl. H04Q 7/00

(52) U.S. Cl. 455/422.1; 455/569.2; 455/432.1

(57) ABSTRACT

The present invention allows for a plurality of communications networks that have overlapping broadcast ranges to coordinate their communication protocols such that communication within each network, and between networks, is facilitated. Each overlapping network includes a point coordinator node operative to coordinate the message transmissions of a plurality of nodes within its communications network. Each network also includes at least one node that is operative to communicate with at least one node in an overlapping network such that communication between the networks is accomplished via the at least one node whereby the communication protocols of the networks are affected to cooperate for facilitating such communication.

### RELATED APPLICATIONS

This application claims priority of U.S. Provisional Patent Applications Ser. No. 60/478,121 filed Jun. 12, 2003 and Ser. No. 60/515,634 filed Oct. 30, 2003, which are incorporated herein by reference.

### FIELD OF THE INVENTION

The present invention relates to wireless communications technology and more particularly to a wireless communications system and protocol that provides the advantages of both centralized message coordination and distributed message coordination between one or more communication networks.

### BACKGROUND OF THE INVENTION

Wireless communications is a technology poised to greatly impact several common human endeavors, including communications, commerce, transportation, medical care, safety and security. As illustrated in FIG. 1, known communication standards refer to a group of communication devices, or nodes, forming a local area network (LAN) as a basic service set (BSS).

There are two basic architectures for basic service sets. The first, point coordination function (PCF), uses a centralized point coordinator (PC) or coordinating node to coordinate messages between nodes. The second, distributed coordination function (DCF), works without a centralized point coordinator. Access to the wireless medium is coordinated using a distributed algorithm running on all nodes in the DCF BSS.

The primary advantage of the distributed coordination function is that it does not rely on a centralized coordinator, making it ideal for situations where established infrastructure is not available, or in environments when a point coordinator might not have high reliability. It is therefore a robust and flexible strategy. The reconfiguration delay (the delay required for reconfiguring the BSS when a node joins the BSS) is minimal, compared to PCF. The primary disadvantage of DCF is that it is designed for asynchronous data transfer on a best-effort traffic basis. That is, there are no guarantees on the packet delay (the delay experienced by packets waiting to be transmitted from one node to another). Further, DCF suffers from significant throughput degradation in high load conditions.

The primary advantage of the point coordination function is that it is designed for real-time traffic, and can make superior guarantees on delay upper bounds. It accomplishes this by coordinating the access to the medium at one point, the point coordinator (PC). Specifically, the PC periodically declares a contention-free period (CFP) using a special beacon frame. During a contention-free period, each slave node (each non-PC node in the BSS) sets its Network Allocation Vector (NAV) as busy. Therefore, no slave node will attempt to use the medium during the CFP unless it is responding to a poll frame from the PC. During each CFP, the PC generally sends one poll frame to each slave node in its polling list, thereby allowing each slave node an opportunity to transmit during the CFP. At the conclusion of the CFP, the PC sends a CF-END frame. Each slave node then resets its NAV. Until the PC declares another CFP, all nodes are allowed to contend for the medium in a contention period using DCF. One contention-free period followed by a contention period comprises a CFP repetition interval.

By allowing each slave node at least one transmission per CFP repetition interval (within the CFP), the PC can guarantee packet delays for each node in the BSS.

The PC transmits beacon frames at regular intervals throughout both the contention-free period and contention period. Each beacon frame indicates the number of subsequent beacon periods until the start of the next CFP.

Because each node that joins the BSS must be recognized and register with the point coordinator, reconfiguration delay is longer for PCF as compared to DCF. The primary disadvantage of PCF is its lack of robustness. If the point coordinator node is lost, the BSS ceases to operate in PCF.

TABLE 1
Comparison of DCF and PCF

| | GUARANTEED | RECONFIG | |
|---|---|---|---|
| | PACKET DELAY | DELAY | ROBUSTNESS |
| Distributed | X | ◯ | Δ |
| Coordination | | | |
| Function (DCF) | | | |
| Point Coordina- | ◯ | Δ | X |
| tion Func- | | | |
| tion (PCF) | | | |

◯ = Good,
Δ = Acceptable,
X = Poor

There is a need for a wireless system that is as robust as DCF and has the guaranteed low-delay for real-time traffic of PCF. For example, vehicular safety applications (e.g. collision warnings, lane-departure warnings, slow-down warnings, etc.), if based on a robust and guaranteed low-delay communications architecture, could potentially reduce the number and severity of vehicular collisions. Currently, no such wireless communications architecture exists.

### SUMMARY OF THE INVENTION

The invention allows for a plurality of communications networks that have overlapping broadcast areas to coordinate their communication protocols such that communication within each network, and between networks, is facilitated. In such case, each network includes at least one node that is operative to communicate with at least one node in an overlapping network such that communication between the networks is accomplished via the at least one node whereby the communication protocols of the networks are affected to cooperate for facilitating such communication.

### BRIEF DESCRIPTION OF THE DRAWINGS

FIG. 1 illustrates two basic types of wireless communication networks or BSSs;

FIG. 2 illustrates a BSS having six nodes wherein one node is the coordinating node or point coordinator;

FIG. 3 is an illustration of FIG. 2 wherein the coordinating node is lost;

FIG. 4 illustrates Node 1 becoming the coordinating node after Node 6 of FIG. 3 is lost;

FIG. 5 illustrates the formation of a single BSS in two-way traffic;

FIG. 6 illustrates two BSSs having point coordinators operating in a common broadcast area;

FIG. 7 illustrates an example of how contention-free periods may be sequentially nested;

FIG. 8 illustrates the inventive ROMO protocol for enhanced BSS communication wherein collision-free periods and collision periods form a repetition interval as according to the invention; and

FIG. 9 illustrates two overlapping BSSs wherein the normal occurrence of node interference is obviated with the use of the ROMO protocol as according to the invention.

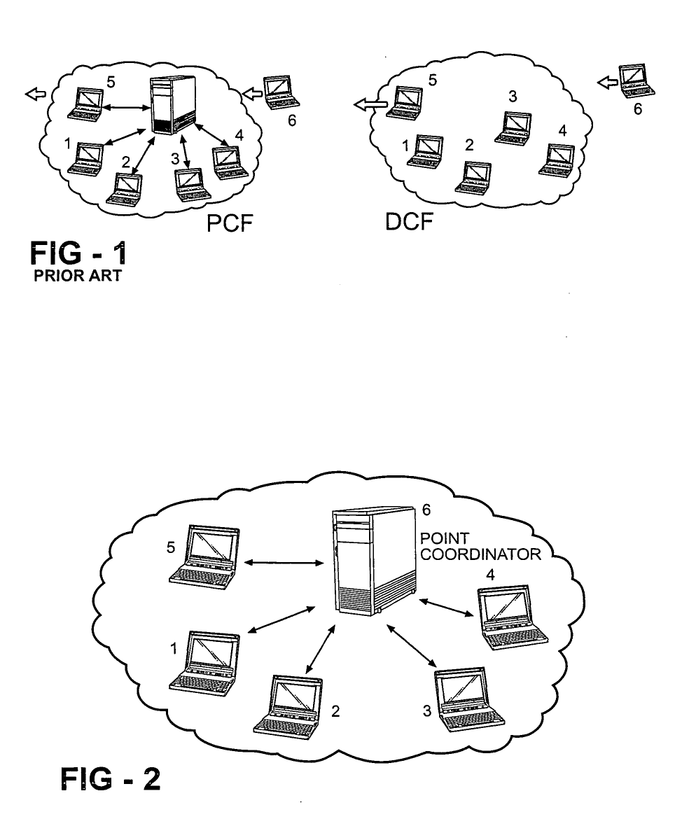

### DESCRIPTION OF THE INVENTION

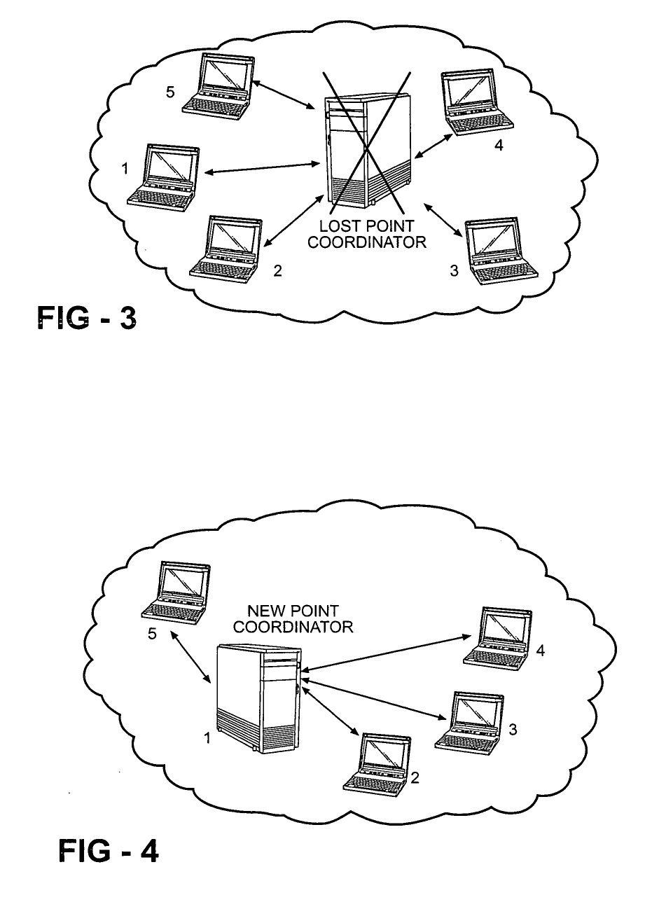

Proposed here is a new communication protocol that combines high robustness and guaranteed low transmission delay. This protocol is a robust version of PCF and will hereinafter be referred to as Robust Mobile Point Coordination Function (ROMO). Nominally, ROMO operates very similarly to PCF, with one PC coordinating access to the wireless media. Further, all slave nodes are assumed to maintain constant contact with the PC during nominal operation. Therefore, ROMO will retain the guaranteed low packet delay of PCF, making it ideal for real-time traffic. However, if the current PC is lost, another ROMO node will quickly detect the loss and assume the role of PC. In FIG. 2, ROMO is shown for a BSS with six nodes. Node 6 operates as the coordinating node, or point coordinator (PC), and coordinates all transmissions during the contention-free period. FIG. 3 shows the loss of the point coordinator. With enough time, Nodes 1-5 will each detect the loss of the PC. Although each node has the capacity to become the PC, only one PC is needed in the BSS. Through a mechanism described later, Node 1 asserts itself as the PC for the BSS. This is shown in FIG. 4. After Node 1 becomes the PC, it conducts all normal PC responsibilities, including adding and removing nodes from the BSS and coordinating the transmissions of nodes during the contention-free period. Nodes 2-5 will view Node 1 as its PC and will monitor the health of the new PC (Node 1). Illustratively, nodes within a BSS may be mobile or non-mobile for facilitating vehicle to vehicle communication and/or vehicle to infrastructure communication.

### Mirroring BSS Member List Through Active Listening

In normal operation of ROMO, a BSS consists of one PC node and zero or more slave (i.e. non-PC) nodes. In FIG. 2, Node 6 is the PC and Nodes 1-5 are slave nodes. Should the PC be lost (as in FIG. 3), one of the slave nodes must assume the role of PC. In fact, all slave nodes should prepare to assume the role of PC (although in many cases, one slave node may be a better choice than others).

To prepare for the possibility of becoming the PC, each slave node must construct, as best it can, a list of the other slave nodes in the BSS. Should a particular slave node become the PC, its list of other BSS slave nodes allows it to quickly resume polling during a contention-free period without requiring each slave node to re-register with the new PC.

Consider Node 1 in FIG. 2. Like all slave nodes, Node 1 has an uninterrupted communications channel with its PC (Node 6). Therefore Node 1 can hear each poll sent by Node 6 to each slave node during a contention-free period. By analyzing these polls, Node 1 can create an ordered list of the slave nodes within Node 6's control, specifically Nodes 2-5. If Node 1 becomes the PC (as in FIG. 4), it can use this list to poll Nodes 2-5.

In addition to listening to polls from Node 6, Node 1 also listens to the responses from each slave node during the contention-free period. By doing this, Node 1 can judge to which of its fellow slave nodes it can communicate. If Node 1 clearly receives the response of each slave node to each poll of Node 6, then it is likely that Node 1 could directly communicate with each of the other slave nodes in the event Node 1 becomes PC. If Node 1 hears only a fraction of the poll responses (say only from Nodes 2 and 5), then Node 1 can determine that it is not able to communicate with each of the other slaves polled by Node 6. Therefore Node 1 would make a less effective PC than the original PC, Node 6. More precisely, Node 1 (as well as all other slave nodes, Nodes 2-5) should count how many other slave nodes it does not hear responding to Node 6's polls. Defining this quantity as slave_missing_response_count(<NODE>), if Node 1 hears responses from Nodes 2-5, then slave_missing_response_count(1)=0. If Node 1 only hears responses from Nodes 2 and 5 (and not Nodes 3 and 4), then slave_missing_response_count(1)=2. Since slave_missing_response_count can change for a particular node each contention-free repetition period, slave_missing_response_count should only be updated at the conclusion of a CFP and maintained until the conclusion of the subsequent CFP.

Ideally, in the event of a PC loss, the slave node with the smallest slave_missing_response_count should become the next PC. This mechanism is described below.

The polling list of a PC may change from CFP repetition interval to CFP repetition interval. A slave node may construct its mirrored BSS member list by considering its observations over several CFP repetition intervals. Similarly, since a node's slave_missing_response_count may change from CFP repetition interval to CFP repetition interval, a slave node may determine its qualification to assume the role to PC by considering its slave_missing_response_count over several CFP repetition intervals.

### Mirroring BSS Member List Through Traffic Indication Map

Another method for mirroring the BSS Member List is to use the Traffic Indication Map (TIM). Each beacon frame from a PC that begins a CFP contains a TIM. Using a single bit for each slave node, the TIM indicates which nodes the PC intends to poll. For ROMO, the PC should set the TIM bit for each slave node in its polling list. Inspection of the TIM informs all slave nodes at least the size, and potentially member's identity, of the poll list.

The TIM uses a single bit to indicate traffic for a particular slave node. The mapping of the bit in the TIM field to the specific slave node MAC address is created as the slave node registers with the PC. These MAC addresses are needed by the slave nodes if they are to create a useful BSS Member List. This association can either be mirrored by the slave nodes by listening to the registration process between the new slave node initiating with the PC, or by the PC informing slave nodes of the associations through direct messaging.

### Detecting Point Coordinator Loss

The robustness of ROMO is achieved by the quick detection and replacement of a lost Point Coordinator. This section explains the detection process. The replacement process is described in later sections.

By definition, each slave node should be able to hear poll frames and beacons from the PC. By carefully monitoring poll, beacon and other frames, each slave is responsible for determining the current health of the PC. The time between certain PC frames is bounded in healthy PC operation. Slave nodes can use timers to determine whether the PC has sent an expected frame within an acceptable amount of time.

This section will specify the monitoring of two different PC frames. The first is the beacon frame. The second is the poll frame.

### Monitoring Beacon Frames

The Point Coordinator broadcasts beacon frames at periodic intervals. Specifically, the PC schedules the broadcast of a beacon frame every target beacon transmission time (TBTT) time units. The beacon frame contains network management information. Each slave learns the TBTT when it joins the BSS. Each beacon frame broadcast by the PC contains a beacon interval field, containing the value of TBTT, thereby reaffirming the TBTT value for all slaves. Using a timer, a slave node can measure the time since the previously received beacon issued from the PC. If too much time expires since the reception of a beacon (accounting for delayed beacons due to a busy medium), the slave node can declare the PC lost and initiate the process to replace the PC.

### Monitoring Poll Frames

During a contention-free period (CFP), slave nodes can expect the PC to send poll frames between each slave node transmission. The time between PC poll frames in the CFP may be much smaller than the beacon rate. During the CFP, slave nodes can continue to determine the health of the PC using beacons. Alternatively, slave nodes can determine the health of the PC by measuring the time between expected poll frames from the PC, as described below.

The time between the beginning of one PC frame (containing a poll) and the beginning of the next PC frame should be no greater than the maximum length of a PC frame (including polls and acknowledgements), plus the maximum length of a slave node frame (including acknowledgements), plus two Inter Frame Space times. If the PC does not issue a frame within a sufficient length of time (as measured by a slave node timer) after the PC's previous frame, a slave node can declare the PC lost and initiate the process to replace the PC.

It may be possible that a slave node temporarily loses contact with the PC during a contention-free period. Consider a specific slave node F that is temporarily blocked from the PC during the CFP. During this blocked period, F will not hear beacon or poll frames from the PC. However, if F can indirectly observe that PC is still functioning, then F should not declare a PC loss. One way for F to detect such a situation is to observe the frames sent by other slave nodes. If F observes other slave nodes sending frames in a manner that suggests they are responding to the PC's polls, F should not declare a PC loss. If F suspects it is simply blocked from a functioning PC, it should not attempt to become the PC. Instead, F will wait until its network allocation vector (NAV) allows sending a packet (possibly waiting up to CFPMaxDuration for the CFP to end) using DCF. If subsequently F receives a poll from either the original PC (or a different PC that replaces the original PC), then F will rejoin the ROMO BSS and once again act as a slave node.

Application or environmental considerations may encourage setting the beacon and the poll timers to longer expiration times before declaring the loss of a PC (e.g. having the beacon timer wait 2×target_beacon_transition_time, or some function of the CFP repetition interval, before declaring PC loss).

Converting a Slave Node to a Point Coordinator (PC) Node There are at least two situations where a slave node would assert itself as a PC. In the first situation, a slave node operating in an existing BSS detects a loss of the PC (using the techniques described above) and attempts to replace the lost PC. In the second situation, a slave node attempts to create a new BSS after detecting the presence of one or more other slave nodes in its area.

In the first situation, since all ROMO slave nodes in the BSS are monitoring the PC's health, if a PC is lost, each slave node has the potential to declare the loss of the PC. However, the first slave node to determine the loss of the PC is not necessarily the best candidate to succeed the lost PC. Instead, the slave node with the greatest connectivity in the BSS, e.g. with the smallest slave_missing_response_count, should be the first to assume the role of PC. When becoming the new PC of a BSS, a node will send a beacon to start a CFP. This beacon shall contain the same service set identifier (SSID) tag (a unique numerical identifier for the BSS) of the recently lost PC. When a slave node receives beacons, polls and other frames from the new PC containing the same SSID tag as the previous PC, the slave node will interpret this new PC as a successor of the previous PC. As an example algorithm, consider a slave node S that determines the PC has been lost. Let t_{S,lost} be the time when S declared the PC to have lost. S should attempt to become the PC, but only after S allows other slave nodes in the BSS with a smaller slave_missing_response_count an opportunity to become the PC. Define missing_assert_wait_time as an interval of time common to all nodes in the BSS. Node S should wait at least slave_missing_response_count(S)×missing_assert_wait_time before attempting to become the PC. This allows other slave nodes with a smaller slave_missing_response_count an opportunity to assume the PC role before Node S.

Since multiple nodes may have the same slave_missing_response_count, a simple contention scheme is proposed. Let assert_pc_backoff be a pseudorandom value drawn from a uniform distribution over the interval [0, missing_assert_wait_time-1]. Node S therefore will wait an additional assert_pc_backoff time before asserting itself as the PC. This backoff provides simple contention resolution between multiple slave nodes with the same slave_missing_response_count. Other schemes are also possible.

Taking the above two concepts together, S will assert itself as the PC for the BSS at time t_{S,assert}, where

t_{S,assert}=t_{S,lost}+slave_{—}missing_{—}response_{—}count(S)×missing_{—}assert_{—}wait_{—}time+assert_{—}pc_backoff (1)

Therefore, once Node S determines a loss of the PC at t_{S,lost}, it will wait an interval of time missing_assert_wait_time for each slave node it did not hear respond to a PC poll in the previous PCF. In addition, it will wait a random assert_pc_backoff interval of time to perform contention with other slaves that share the same slave_missing_response_count.

The above process is guaranteed to choose the slave node with the smallest slave_missing_response_count if each slave node declares the PC loss at the same time, i.e. t_{i,lost} is the same for all slave nodes i. To encourage this, it may be desirable for each slave node to postpone the declaration of a lost PC to a time that will be the same for all slave nodes. If the PC loss occurs during a CFP, one possibility is the time when current CFP would time out, as specified (for all slave nodes) by the CFP-MaxDuration parameter communicated in the beacon frame initiating the current CFP.

At time t_{S,assert}, if S finds the medium idle, it will send a beacon frame containing the CF Parameter Set element and a delivery traffic indication message (DTIM) element, asserting itself as PC. Node S then has two options. As a first option, Node S will begin sending poll frames to all of the other slave nodes in its mirrored BSS member list created to actively listening to the previous PC, as described above. This includes polling slave nodes that Node S did not previously hear and may not be able to communicate with. Node S then becomes the PC for the BSS in all respects. As a second option, Node S could poll only those nodes that it was able to previously hear. This would leave slave_missing_response_count slave nodes excluded from the new BSS. However, this would potentially shorten the CFP managed by Node S, thereby leaving more time for decentralized coordination. Those slave nodes excluded from Node S's new BSS would be free to form their own BSS.

Other nodes in the BSS that receive the beacon frame declaring the start of a CFP from the new PC, Node S, will set their NAVs. They will respond to the poll frames from S, will mirror the BSS Member List and will monitor the health of the new PC, Node S.

Each slave node should be self-aware of its functioning capability. A slave node aware of an internal error state or malfunction should not attempt to become the PC.

For the proposed ROMO, there are two distinct situations where two (or more) PCs find themselves operating in the same area. In the first case, a PC has been lost and two of its slave nodes from the same BSS simultaneously attempt to become the BSS's new PC. In the second case, two different BSSs representing distinct flows of traffic meet on the road.

### Two PCs from the Same BSS

In the first case, the optimal outcome is for one former slave node to succeed the lost PC. Ideally one node has connectivity to all of the remaining slave nodes, its slave_missing_response_count=0. If no slave node has slave_missing_response_count=0, the slave node with the minimum slave_missing_response_count will succeed the lost PC. If more than one slave node has the minimum slave_missing_response_count, the random assert_pc_backoff (see Eq. (1)) should prevent more than one node from asserting itself as the PC at the same time.

However, since it is possible for more than one PC to exist in a BSS after a detected PC loss, there needs to be contention. As a general rule, whenever a PC, Node U, receives a beacon from another PC, Node V, with the same service set identifier (SSID) (from the same BSS), Node U should give up its PC status and fall back to slave node operation, observing Node V as the PC. Optionally, special situations may be implemented where a PC, Node U, upon receiving a beacon with the same SSID from another PC, Node V; reasserts its dominance as BSS PC by resending its own beacon. (Situations where this might occur include when Node V is a long-established PC and Node U incorrectly determined that V is lost, or when V observes that it has a more complete connectivity to the BSS than U). This beacon may include a super-assert flag to enforce its dominance over Node U. Upon receiving this beacon, Node U will fall back to slave node status and respect V as its PC.

### Two PCs from Different BSSs

In the case where two established BSSs occupy the same geographic location, the situation is more complex. There are a number of candidate solutions.

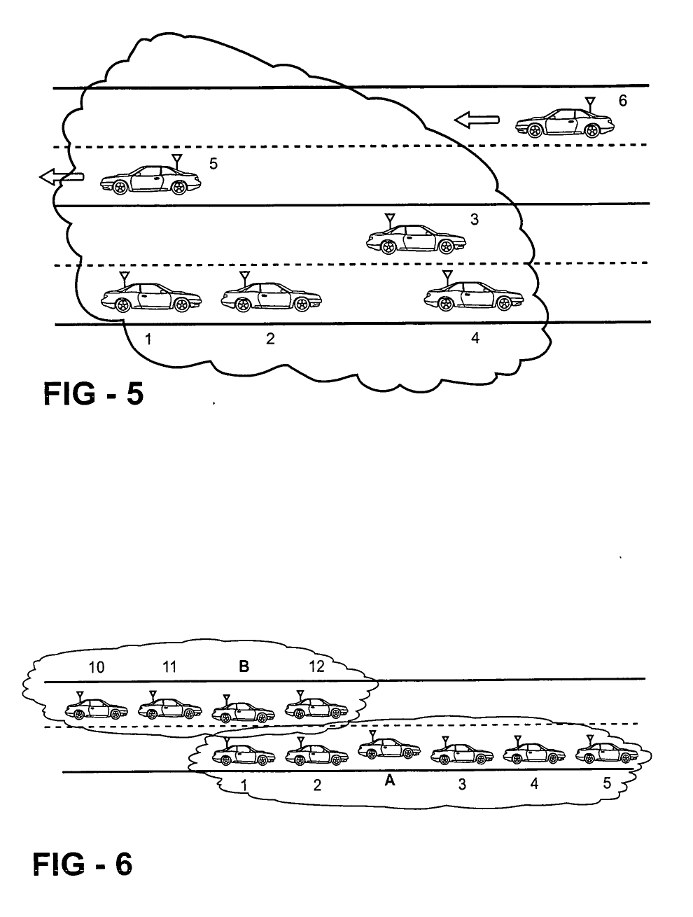

To describe these solutions, consider the following scenario, shown in FIG. 6. There are two BSSs, moving in the same direction, occupying separate lanes. The first BSS comprises Nodes 1-5 plus the point coordinator, Node A. The second BSS comprises Nodes 10-12 plus the point coordinator, Node B. The left lane BSS (with PC B) is moving faster than the right-hand BSS (with PC A).

Point coordinators discover the presence of another BSS when they receive the beacon frames from another point coordinator. In the example shown in FIG. 6, Node B will receive beacons from A and vice versa. Since these beacons will contain distinct SSID tags, each BSS can determine that the other PC belongs to a distinct BSS.

The BSS coordinated by A is larger than that coordinated by B. As a general practice, larger BSSs will dominate smaller BSSs, although this is not required. This scenario serves only to simplify the naming convention of nodes. The solutions outlined below are intended for generalized configurations, not just that shown in FIG. 6. Hence, it is appreciated that the following solutions are applicable for a scenario as illustrated in FIG. 5 wherein a single BSS is formed of vehicles moving in two-way traffic when the vehicles merge into a common broadcast area.

### Merging and Splitting BSSs

One solution is that the two BSSs merge into one BSS with one PC. In the case shown in FIG. 6, Node A could become the PC for all nodes, including Node B. Node A would need to learn the identities of each node in B's BSS, i.e. Nodes B and 10-12, either through direct communication with B or through actively listening to a CFP coordinated by B. After the merge is completed, Node B would become a slave node of A in addition to Nodes 10-12. The CFP of A would include polls to Nodes 1-5, 10-12, and B.

As Nodes 10-12 and B move out of range of A, the original BSS should reform under point coordinator B. This splitting action could result from explicit signaling between A and B. For, example, as B realizes that A's signal strength is waning, B could send an explicit frame to A, reclaiming its original slave Nodes 10-12. Alternatively, after B leaves the communication range of A, B could attempt to reform its original BSS by declaring a CFP and polling its original slave node list (Nodes 10-12). Other explicit and non-explicit split methodologies are possible.

### Co-Existing Distinct BSSs

It is contemplated that ROMO may be used with overlapping point-coordinated BSSs to produce acceptable performance communication environment. Essentially, if a PC attempts to initiate a CFP with a beacon, but finds the medium busy, it adopts DCF-style contention delay before sending the CFP-initiating beacon. The practical result is that, if all point coordinators observe gaps less than a DIFS during their respective CFP, then CFPs should desynchronize. In the example shown in FIG. 6, the CFP coordinated by B would occur in the DCF period following A's CFP, and vice versa.

It may be necessary to create a significant difference between the point interframe space (PIFS) and the distributed interframe space (DIFS) in order to make the intrusion of each BSS's CFP by the other BSS very unlikely. Another possibility is for every node (or possibly just every slave node) to observe the CFP declared by any PC. This would include recognizing the CFP initiating beacon, setting the NAV to the CFPMaxDuration, and observing CF-End frame. Using our example from FIG. 6, if A declares a CFP and Nodes B and 10-12 observe this CFP, then nodes 10-12 must avoid declaring their PC, Node B, as lost while Node B remains quiet throughout as A's CFP.

If this approach is adopted, it is important to note that each PCF period would be competing with all other DCF traffic. In other words, delayed beacons would wait DIFS plus a back-off interval, just like any other DCF frame. For this scheme to work, DCF traffic would need to be limited such as to not crowd out the starts of CFPs. Of course, all CFPs would need to exist within a CFP repetition interval.

### Nesting BSSs

In the nesting scheme described in this section, with many BSSs operating in the same area, the PC of one of the BSSs becomes a major-PC. The other BSSs remain distinct, each with its own PC, but the PCs of these BSSs become minor-PCs. The major-PC begins CFPs by polling all the slave nodes in its own BSS. When the major-PC finishes polling the slave nodes with its BSS, instead of declaring the end of the CFP, the major-PC instructs one minor-PC to poll its slave nodes, then instructs the next minor-PC to do the same. When all minor PCs have polled their respective slave nodes, the super-PC declares the end of the CFP.

To be more specific, consider the case of FIG. 6. Let Node A be the major-PC and Node B be the minor-PC (this can be decided because Node A controls more slave nodes, or by some other means). When Node A sends a beacon to start a CFP, before it starts polling, it waits for Node B to echo the CFP-initiating beacon (in case Node 10 is out of range of Node A). Through this echoing of CFP-initiating beacons, all nodes will observe a CFP and will not contend for the medium without being polled or prompted. Then Node A polls Nodes 1-5. After Nodes 1-5 have been polled, Node A sends a special group-poll frame to Node B. Node B then polls Nodes 10-12. Next, Node B sends a special group-acknowledgement frame back to Node A, signifying that all of B's nodes have been polled. (At this point, if there were another BSS and minor-PC (e.g. Node D), Node A would send Node D a group-poll and allow D to poll its slave nodes.) After all minor-PCs have polled their respective slave nodes, the major-PC, Node A declares a CF-End. This CF-End is then echoed by each minor-PC to each of their respective slave nodes. At this point, the CFP is over and all nodes can use DCF to send frames until Node A initiates the entire nested CFP again.

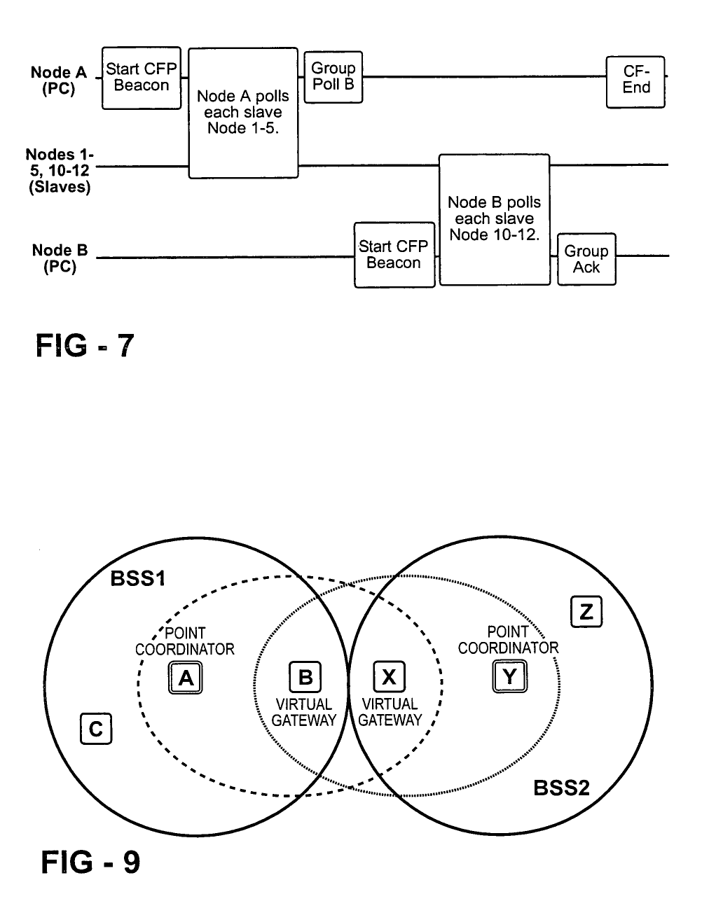

FIG. 7 demonstrates the sequence of frames described in the above example, excluding the echoed Start CFP Beacon and CF-END frames.

As described above, each slave node actively monitors the health of its PC. When a PC does not issue a beacon frame within an expected period of time, a slave node will declare the loss of its PC. In the nesting of PCFs described in this section, PCs are generally required not to transmit during another PC's active polling period. Without making special allowances, the silence of minor-PCs imposed during the CFP could be interpreted as a loss of these minor-PCs by their respective slave nodes.

There are at least three possible solutions to this issue. The first solution is, during a CFP, the active PC (the PC currently polling its slave nodes) will send a beacon at its appointed time, then wait for all other PCs to send a beacon to their respective slave nodes. After all major and minor PCs have sent a beacon, the active PC will continue with its polling. Another approach is for every slave node to respect the beacons and CF-End frames of either the active PC or the major-PC as if it initiated from its own minor-PC. As a third approach, note that each PC (major and minor) is allowed to conduct a polling period within the MaxCFPDuration. Therefore, if the beacon timer time-out is set no less than MaxCFPDuration, no PC loss will be declared.

It may be desirable to define a new Inter Frame Space in order to facilitate ROMO.

Although the case of overlapping BSSs has been presented above, all of the solutions have a common assumption: that the point coordinators of the overlapping BSSs are able to directly communicate with each other. This assumption may not be accurate in many practical situations, rendering these solutions sub-optimal.

The present invention addresses the need for multiple BSSs to coordinate their collision-free periods. The goal of this coordination is that all BSSs that have overlapping broadcast areas choose distinct times to schedule their collision-free periods. In other words, the goal is to desynchronize the collision-free periods of each overlapping BSSs such that, at any given time, no more than one BSS is in a collision-free period.

Unlike previous protocols, the present invention does not require direct communication of point coordinators. Instead, when direct communication between point coordinators is not possible, at least one node within a BSS will be adapted to communicate with nodes in a neighboring BSS and identify when collision-free periods of distinct BSSs overlap in time and space. These nodes will be referred to hereinafter as virtual gateways. When point coordinators are able to communicate directly they are simply described as gateways rather than virtual gateways.

When such a BSS CFP Overlap occurs, the detecting virtual gateway broadcasts a CFP Desynchronizing Frame (CDF). Since virtual gateways like all other nodes know when their current collision-free period is scheduled to end and when the next collision-free period is to begin, the virtual gateway can include this information in its CDF. CDFs are sent with very high priority, for example within a very short inter-frame space.

Referring now to FIG. 9, consider a virtual gateway that sends the CDF to be in BSS1 and the node that receives the CDF to be in BSS2. A node in BSS2 that receives the CDF will forward the CDF to its point coordinator, again, with high priority. When this receiving point coordinator of BSS2 receives a CDF from BSS1, it determines the window of time of the next collision period for BSS1. The receiving point coordinator of BSS2 then attempts to shift its own collision-free period to coincide with the collision period of BSS1.

Ideally the collision-free periods of every overlapping BSS become desynchronized. The present invention achieves this goal without requiring direct communication between the point coordinators of neighboring BSSs.

### Desynchronizing the Collision-Free Periods

Again consider the case depicted in FIG. 9. Nodes A, B, and C comprise one BSS, BSS1, with Node A serving as point coordinator. Nodes X, Y, and Z comprise a second BSS, BSS2, with Node Y serving as point coordinator. Each node can transmit signals a finite distance. This distance is called the broadcast area of a node. The broadcast areas of nodes B and X are shown with a dash-dot oval and a dotted oval, respectively. The broadcast areas of point coordinators A and Y are shown with solid ovals. BSSs also have broadcast areas. The broadcast area of a BSS is the union of the BSS's node broadcast areas.

The point coordinators A and Y are not able to directly communicate with each other, as they are out of each other's range. However, nodes B and X are within each other's broadcast area. Therefore, transmissions from B can potentially interfere with X's ability to transmit and receive messages. Likewise, transmissions from X can potentially interfere with B's ability to transmit and receive messages. Note that point coordinators A and Y cannot hear transmissions from any node in the opposite BSS.

### Interference from Neighboring Groups

In ROMO, A would explicitly direct B to transmit at a specific time with a Poll Frame. Y would similarly direct X to transmit at a specific time. Without coordination between BSS1 and BSS2, it is possible that B and X would be directed by their respective point coordinators to transmit at the same time. Alternatively, X may cause B to miss receiving important information from other nodes. Stated succinctly, B and X can interfere with each other.

Even though the broadcast areas of the point coordinators A and Y do not include nodes from the opposite BSS, their BSSs (e.g. BSS1) include nodes (e.g. B) that have broadcast areas that include nodes (e.g. X) from the opposite BSS. Therefore, BSS1 and BSS2 are described as overlapping BSSs.

### Virtual Gateways

Nodes B and X are called virtual gateways which are nodes able to detect the transmissions of another BSS and possibly able to communicate with nodes from a different BSS. They serve as indirect gateways between the two point coordinators. The use of the term gateway without the modifier virtual is avoided since one point coordinator does not directly route information to another point coordinator. Instead, these virtual gateways relay information previously received from the point coordinator.

### Detecting BSS CFP Overlap

The essence of the present invention is to use virtual gateways to detect the presence of BSS CFP overlap and to signal the overlapping BSS to shift its CFP interval. BSS CFP overlap is defined as two or more BSSs conducting a collision-free period (CFP) at partially overlapping time and within partially overlapping space. In FIG. 9, since the broadcast areas of BSS1 and BSS2 overlap (due to X and B), a BSS CFP overlap occurs if the collision-free periods of the two BSSs overlap for a period of time.

By definition, since virtual gateways are the nodes able to detect the transmissions originating outside of their BSS, the virtual gateways are the nodes that will detect BSS CFP overlap. During a collision-free period, if a node (e.g. X) detects the presence of a signal from any node not entitled to transmit by its point coordinator (Y), the node (X) will determine that the unexpected transmission must be coming from an outside BSS.

### CFP Desynchronizing Frame

If BSS CFP overlap is detected by virtual gateway X in FIG. 9, the virtual gateway (X) broadcasts a CFP Desynchronizing Frame (CDF). This CFP contains the virtual gateway's identity, the identity of its point coordinator (Y), the identity of the BSS (BSS2) using a Basic Service Set Identifier (BSSID), SSID, or similar, and some indication of when the virtual gateway's BSS will enter and exit the next collision period. One method of indicating the start and end of the virtual gateway's next collision period is to communicate the time that the virtual gateway's (X's) current collision-free period is scheduled to end, and the time that the virtual gateway's next collision-free period is scheduled to begin. The virtual gateway (X) will have received this information from the beacon sent by its point coordinator (Y) at the initiation of the collision-free period. The virtual gateway may have other ways of determining or estimating when its BSS will enter and exit the next collision period.

When a recipient node receives a CFP Desynchronizing Frame, it determines if this CDF originated within its BSS or from another BSS. If the recipient node is in the same BSS as the CDF's creator, e.g. if Z receives the CDF from X, then the recipient node will either discard the CDF or optionally rebroadcast the CDF.

If the recipient node is from a different BSS as the CDF's creator, e.g. if B receives a CDF from X, the recipient node (e.g. B) then forwards this message to its point coordinator (e.g. A). This point coordinator attempts to shift its collision-free period to coincide with the collision period of BSS that issued the CDF (e.g. BSS2). If this is not possible, special handling needs to take place, which is described in the section titled Group Size Assumptions.

Desynchronizing the CFP of neighboring BSSs is a high priority task. While BSS CFP overlap continues, guarantees on delay and reliability are very difficult to make. Therefore, transmissions of the CDFs happen with very high priority. One possibility would be to transmit CDFs with short, or even the shortest possible, inter-frame space.

The end goal is that among all overlapping BSSs, only one BSS is in a collision-free period at a time. While one BSS is in a collision-free period, no other overlapping BSS is in a collision period, but instead, a collision-free period.

Note that the virtual gateway concept described as a solution to coordinate the transmissions of groups using the ROMO protocol, can also be used in other situations. For example, a virtual gateway, upon detecting a transmission emanating outside of its group, may broadcast a message to encourage the outside group of nodes to change some aspect of its transmissions so as to reduce interference with the virtual node's group. For example, the virtual node may advertise the channel frequency(ies) used within its group, or possibly the frequency-hop sequence, or possibly some other communication channel parameter, so as to encourage outside nodes to use channels that do not interfere with the virtual gateway's group's transmissions.

### Group Size Assumptions

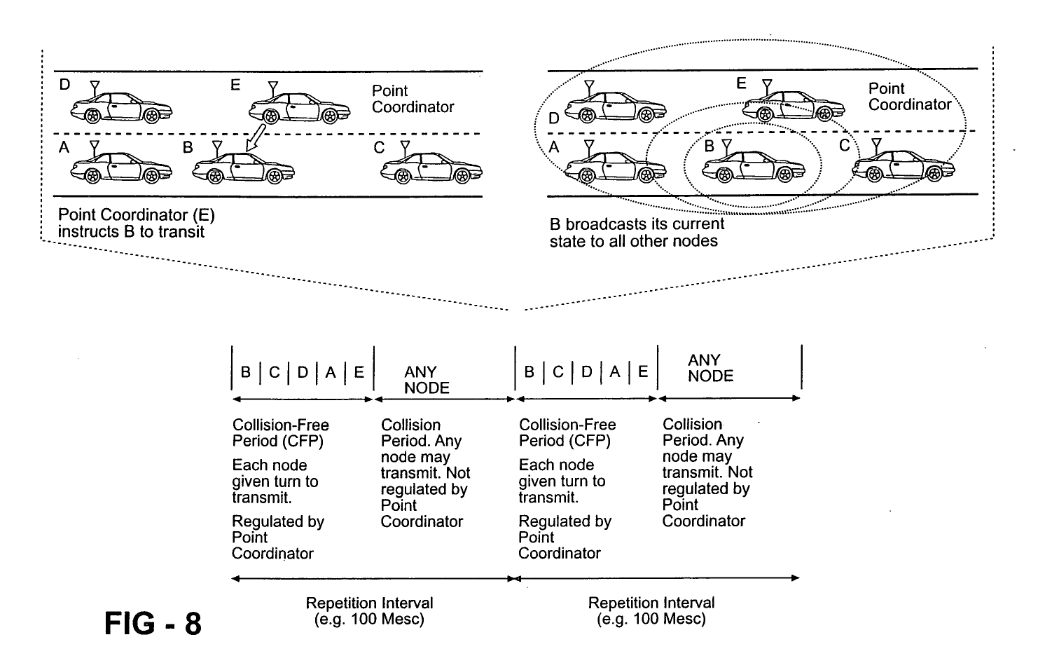

ROMO does not specify the length of the Repetition Interval (L_ri, although 100 msec. is suggested), the length of the collision period (L_cp), the length of the collision-free period (L_cfp), the length of time each node transmits in the collision-free period, or the maximum number of nodes (N_max) comprising a BSS (see FIG. 8).

A few assumptions are made. First, the L_ri is common to all neighboring BSSs. Second, the sum of the L_cfp of all overlapping BSSs is less than L_ri. Without this second assumption, it is impossible for all nodes to have a guaranteed, collision-free transmission. We define the situation where the sum of the L_cfp of all overlapping BSSs is greater than or equal to L_ri as an unsustainable ROMO topology.

An unsustainable ROMO topology can occur when the broadcast areas of nodes are too large. Overly large broadcast areas of nodes cause the broadcast areas' BSSs to needlessly overlap and generally are known to reduce the overall network capacity as it would be possible for each transmission to interfere with a larger number of nodes. One well-known solution to correcting overly large broadcast areas is to reduce the transmission-power, and thus broadcast area, of some fraction (or all) of the nodes. This power reduction is often handled at Layer 1 of the OSI Protocol Stack.

Fortunately, for automotive safety applications, one of the attractive applications for ROMO, there is a natural scaling whereby the nearest vehicles have the greatest urgency to communicate. If an unsustainable ROMO topology occurs in this setting, it is likely due to too many vehicles are trying to share safety related data. The efficacy of a safety application may be only slightly degraded if the most distant nodes are trimmed out of the network topology.

In general, it is assumed that unsustainable ROMO topologies do not occur. However, if an unsustainable ROMO topology is detected, the topology is assumed to be quickly corrected by mechanisms outside of the ROMO protocol, such as power reduction at Layer 1.

As described, the present invention provides a robust, low-delay, fast reconfiguring wireless system wherein the point coordinators may be non-stationary and applicable to a vehicular environment or vehicle-to-vehicle communications or vehicle-to-infrastructure communications.

I claim:

1. A wireless system and protocol for a communications network comprising:
a first communication network having a first plurality of communication nodes wherein at least one node is a coordinating node operative to coordinate communication between said first plurality of communication nodes; and
at least one other communication network having a second plurality of communication nodes wherein at least one node is a coordinating node operative to coordinate communication between said second plurality of communication nodes wherein said first and second plurality of communication nodes are operative to merge when occupying a common broadcast area to form a third plurality of communication nodes wherein at least one node of either said first or second plurality of communication nodes is operative to function as a coordinating node for said third plurality of nodes.

2. The system of claim 1 wherein said third plurality of communication nodes are operative to divide into said first and second plurality of communication nodes when said first and second plurality of communication nodes cease occupying said common broadcast area.

3. A wireless system and protocol for a communications network comprising:
a first communication network having a first plurality of communication nodes wherein at least one node is a coordinating node operative to coordinate communication between said first plurality of communication nodes; and
at least one other communication network having a second plurality of communication nodes wherein at least one node is a coordinating node operative to coordinate communication between said second plurality of communication nodes wherein said first and second coordinating nodes are operative to nest coordinating functions such that both of said first and second plurality of communication nodes has a contention-free period.

4. The system of claim 3 wherein either of said first and second coordinating nodes becomes a major coordinating node and the other becomes a minor coordinating node whereby said major coordinating node performs said coordinating functions amongst communication nodes associated with said major node and thereafter instructs said minor coordinating node to perform said coordinating functions amongst communication nodes associated with said minor node.

5. The system of claim 3 wherein said first and second coordinating nodes are mobile.

6. The system of claim 3 wherein said first communication network and said at least one other communication network are vehicles.

7. A wireless system and protocol for a communications network in a vehicular environment comprising:
a plurality of communication nodes wherein at least one node is a vehicle and at least one node is a coordinating node, said coordinating node operative to coordinate communication between said plurality of communication nodes and wherein at least one other node is operative to detect a loss of said coordinating node and then to function as said coordinating node after detecting the loss.

8. The system of claim 7 wherein said plurality of communication nodes are vehicles within a common broadcast area wherein said wireless system facilitates communication between said vehicles through said coordinating node.

9. The system of claim 7 wherein said system facilitates communication between said at least one vehicle and infrastructure of a communications network through said coordinating node.

10. A wireless system and protocol for a communications network comprising:
a plurality of communication networks within a common broadcast area wherein each of said plurality of communication networks includes a plurality of communication nodes wherein at least one of said plurality of communication nodes is a coordinating node, said coordinating node within a first communication network is operative to coordinate communication between said plurality of communication nodes within said first communication network and at least one other communication network; and
at least one other node within said first communication network operative to facilitate communication between said coordinating node and said at least one other communication network when direct communication between said coordinating node and said at least one other communication network is not attainable or becomes lost.

11. The system of claim 10 wherein said plurality of communication nodes include air, land and sea communication nodes.

12. The system of claim 10 wherein said at least one other node is operative to detect the presence of a node within said at least one other communication network and notify said plurality of nodes within said first communication network of potential interference.

13. The system of claim 10 wherein said at least one other node is operative to transmit information to said at least one other communication network whereby said at least one other communication network is operative to conduct communication between nodes of said at least one other communication network using a communication method such that interference is avoided between said communication networks.

14. The system of claim 10 wherein said coordinating node coordinates a contention-free period for said plurality of communication nodes.

15. The system of claim 10 wherein said coordinating node provides a contention period for said plurality of communication nodes.

16. The system of claim 15 wherein a coordinating node of said at least one other communication network coordinates said contention period of said at least one other communication network to occur before or after said contention free period of said first communication network.
